(19) United States
(12) Patent Application Publication
(10) Pub. No.: US 2020/0168907 A1
(43) Pub. Date: May 28, 2020

(54) NONAQUEOUS ELECTROLYTE SECONDARY BATTERY

(71) Applicant: PANASONIC INTELLECTUAL PROPERTY MANAGEMENT CO., LTD., Osaka-shi, Osaka (JP)

(72) Inventors: Manabu Takijiri, Osaka (JP); Yuta Kuroda, Osaka (JP)

(73) Assignee: PANASONIC INTELLECTUAL PROPERTY MANAGEMENT CO., LTD., Osaka-shi, Osaka (JP)

(21) Appl. No.: 16/634,998

(22) PCT Filed: Jul. 19, 2018
(86) PCT No.: PCT/JP2018/027021

§ 371 Date: Jan. 29, 2020

(30) Foreign Application Priority Data
Jul. 31, 2017 (JP) 2017-148535

(51) Int. Cl. H01M 4/505; H01M 10/0569; H01M 4/525; H01M 10/0525

(52) U.S. Cl. CPC H01M 4/505; H01M 10/0569; H01M 2004/028; H01M 10/0525; H01M 2300/0034; H01M 4/525

(57) ABSTRACT

This nonaqueous electrolyte secondary battery is provided with a positive electrode, a negative electrode and a nonaqueous electrolyte. The nonaqueous electrolyte comprises a nonaqueous solvent that contains a fluorine-containing cyclic carbonate; the positive electrode comprises a positive electrode active material that contains composite oxide particles which contain Ni, Co and Li, while containing at least one of Mn and Al, and wherein the proportion of Ni relative to the total number of moles of the metal elements excluding Li is 50% by mole or more; and the composite oxide particles are in a non-aggregated state, while having a compressive strength of 250 MPa or more.

### TECHNICAL FIELD

The present disclosure relates to technology of a non-aqueous electrolyte secondary battery.

### BACKGROUND ART

Non-aqueous electrolyte secondary batteries which comprise a positive electrode, a negative electrode and a non-aqueous electrolyte and are charged and discharge by transferring lithium ions between the positive electrode and the negative electrode have been used widely as secondary batteries having high outputs and high energy densities in recent years.

For example, Patent Literature 1 discloses that a material, comprising powder of a lithium transition metal complex oxide, wherein powder particles constituting the powder exist almost alone without forming aggregations is used as a positive electrode active material constituting a positive electrode. According to Patent Literature 1, it is disclosed that a non-aqueous electrolyte secondary battery wherein the capacity maintenance rate in charge and discharge cycles is good can be provided using the above-mentioned positive electrode active material.

### CITATION LIST

### Patent Literature

### PATENT LITERATURE 1: Japanese Unexamined Patent Application Publication No. 2003-68300

### SUMMARY

However, an earnest study conducted by the present inventors shows that the effect of suppressing a decrease in the capacity maintenance rate in charge and discharge cycles is little and that it is difficult to suppress a resistance increase in charge and discharge cycles, even though the technology of Patent Literature 1 is applied when a positive electrode active material including complex oxide particles, including Ni, Co and Li and including at least either of Mn and Al, wherein the ratio of Ni to the total number of moles of the metallic elements except Li is 50 mol % or more is used.

Then, it is an advantage of the present disclosure to provide a non-aqueous electrolyte secondary battery which enables suppressing a decrease in the capacity maintenance rate and a resistance increase in charge and discharge cycles when a positive electrode active material including complex oxide particles, including Ni, Co and Li and including at least either of Mn and Al, wherein the ratio of Ni to the total number of moles of the metallic elements except Li is 50 mol % or more is used.

A non-aqueous electrolyte secondary battery according to one aspect of the present disclosure comprises: a positive electrode; a negative electrode; and a non-aqueous electrolyte, the non-aqueous electrolyte includes a non-aqueous solvent including a fluorine-containing cyclic carbonate, the positive electrode includes a positive electrode active material including complex oxide particles, including Ni, Co and Li and including at least either of Mn and Al, wherein the ratio of Ni to the total number of moles of metallic elements except Li is 50 mol % or more, and the complex oxide particles are unaggregated particles and have a compressive strength of 250 MPa or more.

According to a non-aqueous electrolyte secondary battery according to one aspect of the present disclosure, the suppression of a decrease in the capacity maintenance rate and a resistance increase in charge and discharge cycles is enabled when a positive electrode active material including complex oxide particles, including Ni, Co and Li and including at least either of Mn and Al, wherein the ratio of Ni to the total number of moles of the metallic elements except Li is 50 mol % or more is used.

### BRIEF DESCRIPTION OF DRAWINGS

FIG. 1 is a sectional view of a non-aqueous electrolyte secondary battery which is one example of an embodiment.

FIG. 2 is a figure showing a sectional SEM image of complex oxide particles with a high content of Ni in Example 1.

FIG. 3 is a figure showing a sectional SEM image of complex oxide particles with a high content of Ni in Comparative Example 2.

### DESCRIPTION OF EMBODIMENTS

As mentioned above, the effect of suppressing a decrease in the capacity maintenance rate in charge and discharge cycles is little, and it is difficult to suppress a resistance increase in charge and discharge cycles, even though the complex oxide particles exist almost alone without forming aggregations when a positive electrode active material including complex oxide particles, including Ni, Co and Li and including at least either of Mn and Al, wherein the ratio of Ni to the total number of moles of the metallic elements except Li is 50 mol % or more is used. It is considered that this is partly because the complex oxide particles break, and are pulverized or deteriorate due to the volume change of the complex oxide particles accompanying charge and discharge cycles only with the complex oxide particles existing almost alone merely without forming aggregations. It is considered that a decrease in the capacity maintenance rate in charge and discharge cycles cannot be fully suppressed, and it is difficult to suppress a resistance increase in charge and discharge cycles, for example, due to a decrease in electric continuity between the particles, or the like since a non-aqueous electrolyte is decomposed on the surfaces of the pulverized or deteriorated particles, and coatings which are a resistance component are formed in the surfaces of the particles.

Then, the present inventors have earnestly examined and consequently found that the breakage of the complex oxide particles accompanying charge and discharge cycles is suppressed using complex oxide particles having a compressive strength of a predetermined value or more. The present inventors have further found that a fluorine-containing cyclic carbonate was effective as a solvent of a non-aqueous electrolyte which is hardly decomposed on the above-mentioned complex oxide particles. The present inventors have conceived a non-aqueous electrolyte secondary battery of an aspect described hereinafter from this knowledge.

A non-aqueous electrolyte secondary battery according to one aspect of the present disclosure comprises: a positive electrode; a negative electrode; and a non-aqueous electrolyte, the non-aqueous electrolyte includes a non-aqueous solvent including a fluorine-containing cyclic carbonate, the positive electrode includes a positive electrode active material including complex oxide particles, including Ni, Co and Li and including at least either of Mn and Al, wherein the ratio of Ni to the total number of moles of metallic elements except Li is 50 mol % or more, and the complex oxide particles are unaggregated particles and have a compressive strength of 250 MPa or more. Here, the unaggregated state include not only a state in which particles are completely separated into individual primary particles but also a state in which around several (for example, 2 to 15) primary particles are gathered as long as an effect of the present invention is fully taken. Thus, the above-mentioned complex oxide particles are unaggregated particles, and have a compressive strength of 250 MPa or more. The breakage of the complex oxide particles due to charge and discharge cycles is suppressed thereby. It is considered that even though the breakage occurs, the particles are unaggregated particles, an increase in the specific surface area of the particles is therefore suppressed, and the pulverization and the deterioration (for example, the elution of Mn or Al, the production of a compound of nickel and oxygen, and the like) of the complex oxide particles are suppressed. Additionally, it is considered that the decomposition rate of the non-aqueous electrolyte on the surfaces of the above-mentioned complex oxide particles decreases using the non-aqueous electrolyte having a non-aqueous solvent including a fluorine-containing cyclic carbonate; and coatings which are a resistance component are hardly formed on the surfaces of the particles, or the amount of coatings formed is controlled. It is considered that, for example, a decrease in the electric continuity between complex oxide particles is controlled by these, and a decrease in the capacity maintenance rate and a resistance increase accompanying charge and discharge cycles are suppressed.

An example of embodiments will be described in detail hereinafter. The drawing referred to in the explanation of embodiments is described schematically, and the dimensional ratios and the like of components depicted in the drawing may be different from those of actual articles.

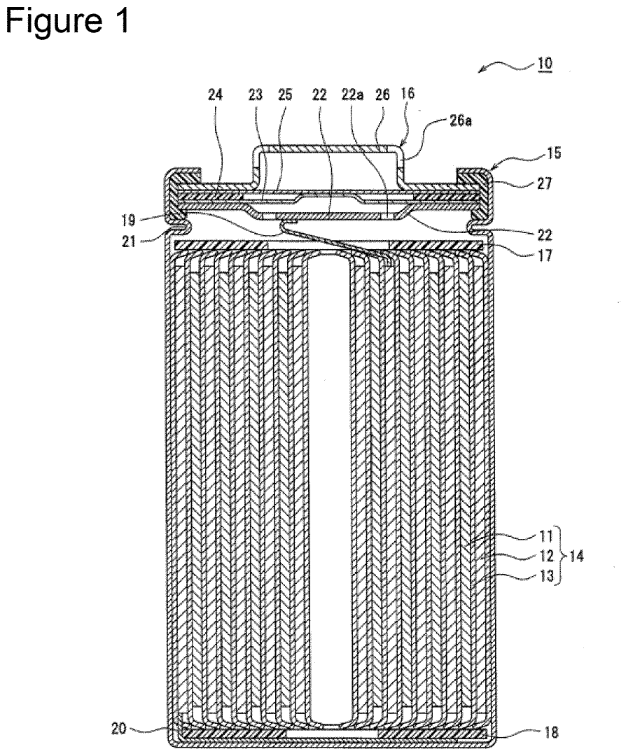

FIG. 1 is a sectional view of a non-aqueous electrolyte secondary battery which is an example of embodiments. A non-aqueous electrolyte secondary battery 10 shown in FIG. 1 comprises: a wound electrode assembly 14 formed by winding a positive electrode 11 and a negative electrode 12 through a separator 13; a non-aqueous electrolyte; insulating plates 17 and 18 disposed above and below the electrode assembly 14, respectively; and a battery case storing the above-mentioned members. The battery case is constituted by a bottomed cylindrical case body 15 and a sealing assembly 16. An electrode assembly in another shape such as a layered electrode assembly in which a positive electrode and a negative electrode through a separator are layered by turns may be applied instead of the wound electrode assembly 14. Examples of the battery case include metal cases such as cylindrical shapes, square shapes, coin shapes and button shapes; and cases made of resins (laminated batteries) formed by laminating resin sheets.

The case body 15 is, for example, a bottomed cylindrical metal container. A gasket 27 is provided between the case body 15 and the sealing assembly 16, and the sealability in the battery case is secured. The case body 15 preferably has a projecting portion 21 which is formed, for example, by pressing a side portion from outside and supports the sealing assembly 16. The projecting portion 21 is preferably formed in a ring shape along the circumferential direction of the case body 15, and supports the sealing assembly 16 on its upper surface.

The sealing assembly 16 has a filter 22 in which the openings of the filter 22a are formed, and vent members disposed on the filter 22. The vent members (a lower vent member 23, an upper vent member 25 and the like) cover the openings of the filter 22a of the filter 22. When the internal pressure of the battery increases by heat generation due to an internal short circuit or the like, the vent members rupture. In the present embodiment, the lower vent member 23 and the upper vent member 25 are provided as the vent members, and an insulating member 24 disposed between the lower vent member 23 and the upper vent member 25, and a cap 26 having cap openings 26a are further provided. Members constituting the sealing assembly 16 have, for example, disk shapes or ring shapes, and the members except the insulating member 24 are electrically connected with each other. The filter 22 and the lower vent member 23 are specifically mutually united at the peripheries. The upper vent member 25 and the cap 26 are mutually united at the peripheries. The lower vent member 23 and the upper vent member 25 are connected with each other at the centers, and the insulating member 24 is between the peripheries. When the internal pressure increases by heat generation due to an internal short circuit or the like, for example, the thin portion of the lower vent member 23 ruptures. The upper vent member 25 swells to the cap 26 side thereby, and are separated from the lower vent member 23. The electrical connection between both is cut off thereby.

In the non-aqueous electrolyte secondary battery 10 shown in FIG. 1, a positive electrode lead 19 attached to the positive electrode 11 extends to the sealing assembly 16 side through the through hole of the insulating plate 17, and a negative electrode lead 20 attached to the negative electrode 12 extends to the bottom side of the case body 15 through the outside of the insulating plate 18. For example, the positive electrode lead 19 is connected with the bottom surface of the filter 22, which is the bottom plate of the sealing assembly 16, by welding or the like. The cap 26, which is the top plate of the sealing assembly 16 electrically connected with the filter 22, is a positive electrode terminal. The negative electrode lead 20 is connected with the bottom of the inside of the case body 15 by welding or the like. The case body 15 is a negative electrode terminal.

[Non-Aqueous Electrolyte]

A non-aqueous electrolyte includes a non-aqueous solvent including a fluorine-containing cyclic carbonate and an electrolyte salt dissolved in the non-aqueous solvent. The non-aqueous electrolyte is not limited to a liquid electrolyte (non-aqueous electrolytic solution), and may be a solid electrolyte using a gel polymer or the like.

The fluorine-containing cyclic carbonate included in the non-aqueous solvent is not particularly limited as long as the carbonate is a cyclic carbonate containing at least one fluorine atom. Examples of the carbonate include monofluoroethylene carbonate (FEC), 1,2-difluoroethylene carbonate, 1,2,3-trifluoropropylene carbonate, 2,3-difluoro-2,3-butylene carbonate and 1,1,1,4,4,4-hexafluoro-2,3-butylene carbonate. These may be singly or in combinations of two or more. Among these, monofluoroethylene carbonate (FEC) is preferable from the viewpoint of suppressing the amount of hydrofluoric acid generated at high temperature, or the like.

The content of the fluorine-containing cyclic carbonate in the non-aqueous solvent is, for example, preferably 2% by volume or more, and more preferably 10% by volume or more. When the content of the fluorine-containing cyclic carbonate in the non-aqueous solvent is less than 2% by volume, for example, the decomposition rate of the non-aqueous electrolyte on the positive electrode 11 is high, and the effect of suppressing a decrease in the capacity maintenance rate or a resistance increase in charge and discharge cycles may decrease as compared with when the content satisfies the above-mentioned range. The upper limit value of the content of the fluorine-containing cyclic carbonate in the non-aqueous solvent is preferably 30% by volume or less, and more preferably 20% by volume or less in view of the amount of gas generated in the battery, and the like.

The non-aqueous solvent may include, for example, a non-fluorine-containing solvent besides the fluorine-containing cyclic carbonate. Examples of the non-fluorine-containing solvent include cyclic carbonates; chain-like carbonates; carboxylate esters; cyclic ethers, chain-like ethers; nitriles such as acetonitrile; amides such as dimethylformamide; and mixed solvents of these.

Examples of the above-mentioned cyclic carbonates include ethylene carbonate (EC), propylene carbonate (PC) and butylene carbonate. Examples of the above-mentioned chain-like carbonates include dimethyl carbonate, methyl ethyl carbonate (EMC), diethyl carbonate, methyl propyl carbonate, ethyl propyl carbonate and methyl isopropyl carbonate. These may be singly or in combinations of two or more.

Examples of the above-mentioned carboxylate esters include methyl acetate, ethyl acetate, propyl acetate, methyl propionate (MP), ethyl propionate and γ-butyrolactone. These may be singly or in combinations of two or more.

Examples of the above-mentioned cyclic ethers include 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol and crown ethers. These may be singly or in combinations of two or more.

Examples of the above-mentioned chain-like ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, and benzyl ethyl ether, diphenyl ether, dibenzyl ether, o-dimethoxybenzene, 1,2-diethoxyethane, 1, 2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether and tetraethylene glycol dimethyl. These may be singly or in combinations of two or more.

The electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li (P(C₂O₄) F₄), LiPF₆₋ₓ(CₙF₂ₙ₊₁)ₓ wherein 1<x<6, and n is 1 or 2, LiB₁₀Cl₁₀, LiCl, LiBr, LiI, lithium chloroborane, lithium lower aliphatic carboxylates, borates such as Li₂B₄O₇ and Li(B(C₂O₄)F₂), and imide salts such as LiN(SO₂CF₃)₂ and LiN(C₁F₂₁₊₁SO₂)(CₘF₂ₘ₊₁SO₂) wherein 1 and m are integers of 0 or more. These lithium salts may be used singly or as a mixture of two or more. Among these, LiPF₆ are preferably used from the viewpoints of ion conductivity, electrochemical stability and the like. The concentration of the lithium salt is preferably 0.8 to 1.8 mol per 1 L of the non-aqueous solvent.

[Positive Electrode]

The positive electrode 11 comprises, for example, a positive electrode current collector and a positive electrode active material layer formed on the positive electrode current collector. Foil of a metal such as aluminum which is stable in the potential range of the positive electrode, a film wherein the metal is disposed on the outer layer, or the like can be used for the positive electrode current collector.

The positive electrode active material layer includes a positive electrode active material. The positive electrode active material layer preferably include a binding agent in that positive electrode active materials can be bound to secure the mechanical strength of the positive electrode active material layer, or the binding property between the positive electrode active material layer and the positive electrode current collector can be increased. The positive electrode active material layer preferably includes a conductive agent in that the conductivity of the layer can be improved.

The positive electrode active material includes complex oxide particles, including Ni, Co and Li and including at least either of Mn and Al, wherein the ratio of Ni to the total number of moles of the metallic elements except Li is 50 mol % or more. This complex oxide particles will be called complex oxide particles with a high content of Ni hereinafter.

The complex oxide particles with a high content of Ni are preferably, for example, complex oxide particles represented by the general formula LiₓNi_{1-y-z}Co_{y}M_{z}O₂ wherein 0.9≤x≤1.2, 0<y+z<0.5, and M is at least one metallic element of the group consisting of Al and Mn. Although the rate of Ni of the complex oxide particles with a high content of Ni may be 50 mol % or more as mentioned above, the rate is preferably 80 mol % or more and 95 mol % or less (in the case of the above-mentioned general formula, it is preferable that 0.05≤y+z≤0.2), for example, from the viewpoint that the capacity of the non-aqueous electrolyte secondary battery can be increased. The complex oxide particles with a high content of Ni may include metallic elements other than Li, Ni, Co, Al and Mn, and examples of the metallic elements include Na, Mg, Sc, Y, Fe, Cu, Zn, Cr, Pb, Sb and B.

The average particle size (D50) of the complex oxide particles with a high content of Ni is preferably, for example, 2 μm or more and 20 μm or less. When the average particle size (D50) is less than 2 μm and more than 20 μm, the packing density in the positive electrode active material layer may decrease, and the capacity of the non-aqueous electrolyte secondary battery may decrease as compared with when the above-mentioned range is satisfied. Particles which are objects of the measurement of the average particle size include particles in not only a state in which particles are completely separated into individual primary particles but also a state in which around several (for example, 2 to 15) primary particles are gathered to be one particle. The average particle size (D50) of the positive electrode active material can be measured by laser diffractometry, for example, using MT3000II manufactured by MicrotracBEL Corp.

The complex oxide particles with a high content of Ni are unaggregated particles. That is, the particles exist in the state in which particles are completely separated into individual primary particles, or exist in the state in which around several (for example, 2 to 15) primary particles are gathered in the positive electrode active material layer. The unaggregated state of the complex oxide particles with a high content of Ni is observed by sectional SEM images through a scanning electron microscope (SEM). For example, the positive electrode 11 is embedded into a resin, a section of the positive electrode is prepared by cross section polisher (CP) processing or the like, and the section of the positive electrode active material layer in this section is photographed through the SEM. Alternatively, powder of the lithium transition metal oxide is embedded into a resin, a particle section of the lithium transition metal oxide is prepared by cross section polisher (CP) processing or the like, and this section is photographed through the SEM. Particles wherein the particle sizes confirmed in a sectional SEM image are in the error range of 10% or less from the volume average particle size are first selected, and the primary particle sizes are confirmed. Each primary particle and each aggregated particle are considered as true spheres, and the quantification of a state in which primary particles are gathered is calculated by the ratio of the volume of the primary particle to the volume estimated from the volume average particle.

Although the compressive strength of the complex oxide particles with a high content of Ni may be 250 MPa or more, the compressive strength is, for example, preferably 400 MPa or more, and more preferably 600 MPa or more in that the breakage of the particles accompanying charge and discharge cycles is suppressed. Although the upper limit value of the compressive strength of the complex oxide particles with a high content of Ni is not particularly limited, the upper limit value is preferably 1500 MPa or less, for example, from the viewpoint of the performance of the material. The compressive strength is measured by a method prescribed by JIS-R1639-5.

The content of the complex oxide particles with a high content of Ni is, for example, preferably 30% by mass or more and 100% by mass or less, and more preferably 80% by mass or more and 95% by mass or less based on the total amount of the positive electrode active material. When the content of the complex oxide particles with a high content of Ni in the positive electrode active material layer is less than 30% by mass, for example, the effect of suppressing a decrease in the capacity maintenance rate and a resistance increase in charge and discharge cycles may decrease as compared with when the above-mentioned range is satisfied. The positive electrode active material may include particles of a positive electrode active material other than the complex oxide particles with a high content of Ni, examples of the particles include complex oxide particles such as LiCoO₂ and LiMn₂O₄ not including Ni, and complex oxide particles wherein the ratio of Ni to the total number of moles of the metallic elements except Li is less than 50 mol %.

The content of the positive electrode active material is, for example, preferably 70% by mass or more and 98% by mass or less, and more preferably 80% by mass or more and 95% by mass or less based on the total amount of the positive electrode mixture layer.

An example of a method for producing complex oxide particles with a high content of Ni will be described.

A method for producing complex oxide particles with a high content of Ni include: a complex hydroxide synthesis step of obtaining a Ni, Co and Al complex hydroxide, a Ni, Co and Mn complex hydroxide, or the like; a raw material mixing step of mixing the complex hydroxide and a lithium compound to obtain a raw material mixture; and a firing step of firing the raw material mixture to obtain complex oxide particles with a high content of Ni.

Examples of the complex hydroxide synthesis step include a coprecipitation method for dropping a solution of an alkali such as sodium hydroxide with stirring a solution of metal salts including Ni, Co, Al (or Mn) and the like, and adjusting the pH to the alkali side (for example, 8.5 to 11.5) to deposit (coprecipitate) a Ni, Co and Al complex hydroxide or a Ni, Co and Mn complex hydroxide. The complex hydroxide synthesis step preferably includes an aging step of maintaining the complex hydroxide in the reaction solution as it is after the precipitation of the complex hydroxide. The complex oxide particles with a high content of Ni obtained finally is easily obtained as unaggregated particles thereby.

The raw material mixing step is a method of, for example, mixing the above-mentioned complex hydroxide and a lithium compound such as lithium hydroxide, lithium carbonate or lithium nitrate to obtain a raw material mixture. Adjusting the mixing ratio of the complex hydroxide to the lithium compound enables controlling the compressive strength of the complex oxide particles with a high content of Ni obtained finally and preparing unaggregated particles. The mixing ratio of the complex hydroxide to the lithium compound is preferably a ratio wherein the metallic elements (Ni+Co+Al or Mn):Li is in the range of 1.0:1.02 to 1.0:1.2 by molar ratio in that the complex oxide particles with a high content of Ni are prepared as unaggregated particles, and the compressive strength is adjusted to 250 MPa or more.

The firing step is a method, for example, for firing the above-mentioned raw material mixture in an oxygen atmosphere to obtain complex oxide particles with a high content of Ni. Also adjusting the firing temperature of the raw material mixture enables controlling the compressive strength of the complex oxide particles with a high content of Ni obtained finally and preparing unaggregated particles. The firing temperature of the raw material mixture is, for example, preferably in the range of 750° C. or more and 1100° C. or less in that the complex oxide particles with a high content of Ni are prepared as unaggregated particles, and the compressive strength is adjusted to 250 MPa or more. The firing temperature is preferably 20 hours to 150 hours, and more preferably 20 hours to 100 hours. When the firing time of complex oxide particles with a high content of Ni is more than 150 hours, for example, the material physical properties or the electrochemical characteristics may be deteriorated as compared with when the firing time is 150 hours or less.

Examples of the conductive agent included in the positive electrode active material layer include carbon powders such as carbon black, acetylene black, ketjen black and graphite. These may be used singly or in combinations of two or more.

Examples of the binding agent included in the positive electrode active material layer include fluorine-containing polymers and rubber-based polymers. Examples of the fluorine-containing polymers include polytetrafluoroethylene (PTFE), polyvinylidene fluoride (PVDF), or modified product thereof. Examples of the rubber-based polymers include an ethylene-propylene-isoprene copolymer and an ethylene-propylene-butadiene copolymer. These may be used singly or in combinations of two or more.

The positive electrode 11 of the present embodiment is obtained, for example, by forming a positive electrode active material layer on a positive electrode current collector by applying positive electrode mixture slurry including the positive electrode active material, the conductive agent, the binding agent and the like and drying the slurry, and rolling the positive electrode mixture layer.

[Negative Electrode]

The negative electrode 12 comprises, for example, a negative electrode current collector and a negative electrode active material layer formed on the negative electrode current collector. Foil of a metal such as copper which is stable in the potential range of the negative electrode, a film wherein the metal is disposed on the outer layer, or the like can be used for the negative electrode current collector. The negative electrode active material layer includes, for example, a negative electrode active material, a binding agent, a thickening agent, and the like.

The negative electrode active material is not particularly limited as long as the active material is a material which can occlude and emit lithium ions, and examples of the active material include metal lithium; lithium alloys such as a lithium-aluminum alloy, a lithium-lead alloy, a lithium-silicon alloy and a lithium-tin alloy; carbon materials such as graphite, coke and a fired organic substance; and metal oxides such as SnO₂, SnO and TiO₂. These may be used singly or in combinations of two or more.

Although, for example, a fluorine-containing polymer, a rubber-based polymer, or the like can also be used as the binding agent, as is the case with the positive electrode, a styrene-butadiene copolymer (SBR) or a modified product thereof may be used.

Examples of the thickening agent include carboxymethyl cellulose (CMC) and polyethylene oxide (PEO). These may be used singly or in combinations of two or more.

The negative electrode 12 of the present embodiment is obtained, for example, by forming a negative electrode active material layer on a negative electrode current collector by applying negative electrode mixture slurry including the negative electrode active material, the binding agent, the thickening agent and the like and drying the slurry, and rolling the negative electrode active material layer.

[Separator]

For example, a porous sheet or the like having ion permeability and insulation properties is used for the separator 13. Specific examples of the porous sheet include fine porous thin films, woven fabrics and nonwoven fabrics. As the material of the separator, olefin-based resins such as polyethylene and polypropylene; cellulose; and the like are preferable. The separator may be a layered body having a cellulose fiber layer and a thermoplastic resin fiber layer of an olefin-based resin or the like. The separator may be a multilayer separator including a polyethylene layer and a polypropylene layer, and a separator wherein a material such as an aramid-based resin or a ceramic is applied to the surface of the separator may be used.

### EXAMPLES

Although the present disclosure will be further described by Examples hereinafter, the present disclosure is not limited to the following Examples.

### Example 1

[Production of Complex Oxide Particles with High Content of Ni]

[Ni_{0.5}Co_{0.2}Mn_{0.3}](OH)₂ obtained by a coprecipitation method and Li₂CO₃ were mixed in an Ishikawa-type grinding mortar so that the molar ratio of Li to the total amount of Ni, Co and Mn was 1.1:1.0. Then, this mixture was fired in the air atmosphere at 1000° C. for 20 hours to obtain complex oxide particles with a high content of Ni (active material A). The compressive strength of the obtained complex oxide particles with a high content of Ni was 570 MPa. The measuring method is as mentioned above.

The obtained complex oxide particles with a high content of Ni were embedded into a resin, a section of the particles was prepared by cross section polisher (CP) processing, and this section was observed through a SEM.

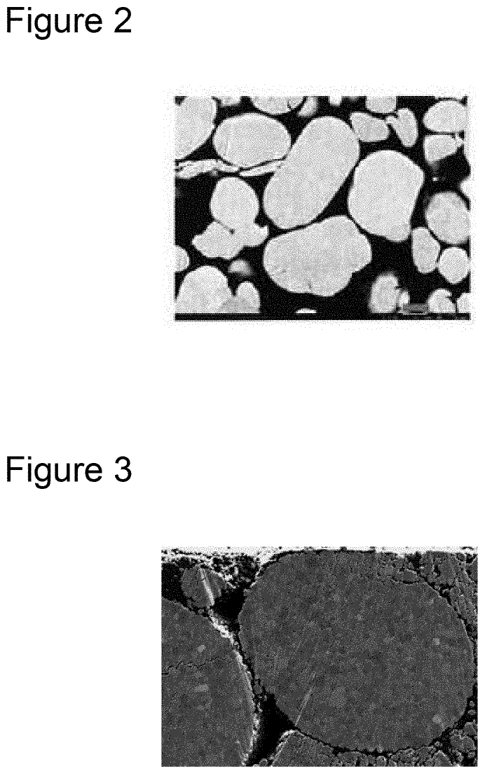

FIG. 2 shows a sectional SEM image of the complex oxide particles with a high content of Ni in Example 1. As shown in FIG. 2, the complex oxide particles with a high content of Ni existed in a state in which particles were completely separated into individual primary particles, or existed in a state in which 2 to 10 primary particles were gathered, and were unaggregated particles in Example 1. When, in the positive electrode manufactured below, its section is observed through the SEM, the complex oxide particles with a high content of Ni existed in a state in which particles were completely separated into individual primary particles, or existed in a state in which 2 to 5 primary particles were gathered in the positive electrode mixture layer, and existed in a state of unaggregated particles in the positive electrode active material layer.

[Manufacturing of Positive Electrode]

The above-mentioned complex oxide particles with a high content of Ni as a positive electrode active material, acetylene black as a conductive agent, and polyvinylidene fluoride as a binding agent were mixed so that the mass ratio was 91:7:2. N-methyl-2-pyrrolidone was then added to prepare positive electrode mixture slurry. Subsequently, this positive electrode mixture slurry was applied to both sides of the positive electrode current collector comprising aluminum foil, and this was dried and then rolled with a rolling roller to manufacture a positive electrode in which positive electrode active material layers were formed on both sides of the positive electrode current collector.

[Manufacturing of Negative Electrode]

Graphite as a negative electrode active material, a styrene-butadiene copolymer (SBR) as a binding agent, and carboxymethyl cellulose (CMC) as a thickening agent were mixed so that the mass ratio was 100:1:1, water was added to prepare negative electrode mixture slurry. Subsequently, the negative electrode mixture slurry was applied to both sides of a negative electrode current collector comprising copper foil, and this was dried and then rolled with the rolling roller to manufacture a negative electrode in which negative electrode active material layers were formed on both sides of the negative electrode current collector.

[Preparation of Non-Aqueous Electrolyte]

LiPF₆ was dissolved in a mixed solvent obtained by mixing monofluoroethylene carbonate (FEC), ethylene carbonate (EC), propylene carbonate (PC), dimethyl carbonate (DMC) and ethyl methyl carbonate (EMC) so that the volume ratio was 10:10:5:35:40 so that the concentration was 1.4 mol/L. A non-aqueous electrolyte was prepared.

[Manufacturing of Non-Aqueous Electrolyte Secondary Battery]

The above-mentioned positive electrode and negative electrode were wound through a separator to manufacture an electrode assembly, the electrode assembly was stored with the above-mentioned non-aqueous electrolyte in a bottomed cylindrical battery case, and the opening of the battery case was sealed with a gasket and a sealing assembly. This was used as the non-aqueous electrolyte secondary battery of Example 1.

### Example 2

A non-aqueous electrolyte secondary battery was manufactured in the same way as in Example 1 except that a mixed solvent obtained by mixing monofluoroethylene carbonate (FEC), ethylene carbonate (EC), propylene carbonate (PC), dimethyl carbonate (DMC) and ethyl methyl carbonate (EMC) at a volume ratio of 2:18:5:35:40 was used in the preparation of a non-aqueous electrolyte.

### Example 3

In the production of complex oxide particles with a high content of Ni, [Ni_{0.88}Co_{0.09}Al_{0.03}](OH)₂ obtained by the coprecipitation method and LiOH were mixed in an Ishikawa-type grinding mortar so that the molar ratio of Li to the total amount of Ni, Co and Al was 1.1:1.0. Then, this mixture was fired in an oxygen atmosphere at 780° C. for 50 hours to obtain complex oxide particles with a high content of Ni (active material B). A positive electrode was manufactured in the same way as in Example 1, and a non-aqueous electrolyte secondary battery was manufactured in the same way as in Example 1 except that this complex oxide particles with a high content of Ni was used.

The compressive strength of the complex oxide particles with a high content of Ni obtained in Example 3 was 256 MPa. The obtained complex oxide particles with a high content of Ni were embedded into a resin, and a section of the particles was prepared by cross section polisher (CP) processing. When this section was observed through the SEM, the particles were unaggregated particles. Also, in a section of the positive electrode, the complex oxide particles with a high content of Ni existed in the state of unaggregated particles in the positive electrode mixture layer.

### Comparative Example 1

A non-aqueous electrolyte secondary battery was manufactured in the same way as in Example 1 except that a mixed solvent obtained by mixing ethylene carbonate (EC), propylene carbonate (PC), dimethyl carbonate (DMC) and ethyl methyl carbonate (EMC) at a volume ratio of 20:5:35:40 without adding monofluoroethylene carbonate (FEC) was used in the preparation of a non-aqueous electrolyte.

### Comparative Example 2

Complex oxide particles with a high content of Ni were obtained in the same way as in Example 1 (active material C) except that the molar ratio of Li to the total amount of Ni, Co and Mn was changed into 1.05:1.0, and the firing temperature was changed into 900° C. in the production of complex oxide particles with a high content of Ni. A positive electrode was manufactured in the same way as in Example 1 except that this complex oxide particles with a high content of Ni was used. A non-aqueous electrolyte secondary battery was manufactured in the same way as in Example 1 except that the positive electrode was used.

The compressive strength of the complex oxide with a high content of Ni obtained in Comparative Example 2 was 132 MPa. The complex oxide particles with a high content of Ni obtained in Comparative Example 2 were embedded into a resin, a section of the particles was prepared by cross section polisher (CP) processing, and this section was observed through the SEM.

FIG. 3 is a sectional SEM image of the complex oxide particles with a high content of Ni in Comparative Example 2. As shown in FIG. 3, the complex oxide particles with a high content of Ni were aggregated particles wherein hundreds of primary particles or more were gathered in Comparative Example 2. Also, in a section of the positive electrode, the complex oxide particles with a high content of Ni existed in the state of aggregated particles wherein hundreds of primary particles or more were gathered in the positive electrode mixture layer.

### Comparative Example 3

A non-aqueous electrolyte secondary battery was manufactured in the same way as in Example 1 except that the positive electrode manufactured in Comparative Example 2 was used, and a mixed solvent obtained by mixing monofluoroethylene carbonate (FEC), ethylene carbonate (EC), propylene carbonate (PC), dimethyl carbonate (DMC) and ethyl methyl carbonate (EMC) at a volume ratio of 5:15:5:35:40 in the preparation of a non-aqueous electrolyte.

### Comparative Example 4

A non-aqueous electrolyte secondary battery was manufactured in the same way as in Example 1 except that the positive electrode manufactured in Comparative Example 2 was used, and the non-aqueous electrolyte prepared in Comparative Example 1 was used.

### Comparative Example 5

In the production of complex oxide particles with a high content of Ni, [Ni_{0.88}Co_{0.09}Al_{0.03}](OH)₂ obtained by the coprecipitation method and LiOH were mixed in an Ishikawa-type grinding mortar so that the molar ratio of Li to the total amount of Ni, Co and Al was 1.05:1.0. Then, this mixture was fired in an oxygen atmosphere at 750° C. for 10 hours to obtain complex oxide particles with a high content of Ni (active material D). A positive electrode was manufactured in the same way as in Example 1 except that this complex oxide particles with a high content of Ni were used, and a non-aqueous electrolyte secondary battery was manufactured in the same way as in Example 1.

The compressive strength of the complex oxide with a high content of Ni obtained in Comparative Example 5 was 88 MPa. The complex oxide particles with a high content of Ni obtained in Comparative Example 5 were embedded into a resin, and a section of the particles was prepared by cross section polisher (CP) processing. When this section was observed through the SEM, the complex oxide particles with a high content of Ni were aggregated particles wherein hundreds of primary particles or more were gathered. Also, in the section of a positive electrode, the complex oxide particles with a high content of Ni existed in the state of aggregated particles wherein hundreds of primary particles or more were gathered in the positive electrode mixture layer.

[Measurement of Capacity Maintenance Rate in Charge and Discharge Cycles]

At an environmental temperature of 25° C., each of the non-aqueous electrolyte secondary batteries of Examples 1 and 2 and Comparative Examples 1 to 4 was subjected to constant current charge at a constant current of 0.5 It until the voltage was 4.3 V, the battery was then subjected to constant voltage charge until the current reached 0.05 It, and the battery was subjected to constant current discharge at a constant current of 0.5 It until the voltage was 3.0 V. This charge and discharge were performed in 300 cycles. In each of the non-aqueous electrolyte secondary batteries of Example 3 and Comparative Example 5, the charge and discharge were performed in 300 cycles under the same conditions as the above except that the charging voltage was changed from 4.3 V to 4.2 V.

The capacity maintenance rate in charge and discharge cycles of each of the non-aqueous electrolyte secondary batteries of the Examples and the Comparative Examples was determined by the following expression. It is shown that a decrease in charge and discharge cycle characteristics are further suppressed as this value becomes higher.

Capacity maintenance rate=(discharge capacity at 300th cycle/discharge capacity at 1st cycle)×100

[Measurement of Direct-Current Resistance (DCR) in Charge and Discharge Cycles]

Each of the non-aqueous electrolyte secondary batteries of the Examples and the Comparative Examples was charged at an environmental temperature of 25° C. and a constant current of 0.5 It to a SOC of 50%. The voltage at this time was V₀. Next, discharge was performed at a constant current of 0.5 It for 10 seconds. The voltage at this time was V₁. The direct-current resistance (DCR) was calculated from the following expression. This is an initial direct-current resistance value.

DCR=(V₀−V₁)/0.5 It

At an environmental temperature of 25° C., each of the non-aqueous electrolyte secondary batteries of Examples 1 and 2 and Comparative Examples 1 to 4 was subjected to constant current charge at a constant current of 0.5 It until the voltage was 4.3 V, and the battery was then subjected to constant current discharge at a constant current of 0.5 It until the voltage was 3.0 V. This charge and discharge were performed in 300 cycles. The direct-current resistance (DCR) was determined by the same method as the above. In each of the non-aqueous electrolyte secondary batteries of Example 3 and Comparative Example 5, the charge and discharge were performed in 300 cycles under the same conditions as the above except that the charging voltage was changed from 4.3 V to 4.2 V, and the direct-current resistance (DCR) was determined by the same method as the above. This is defined as a direct-current resistance value after charge and discharge cycles.

The rate of increase in resistance in charge and discharge cycles of the non-aqueous electrolyte secondary battery of each of the Examples and the Comparative Examples was determined by the following expression.

Rate of increase in resistance in charge and discharge cycles=(direct-current resistance value after charge and discharge cycles/initial direct-current resistance value)×100

Table 1 shows the results of the composition and physical properties of a positive electrode active material used in each of the Examples and the Comparative Examples; the FEC content; and the capacity maintenance rate and the rate of increase in resistance in charge and discharge cycles (300 cycles) of the non-aqueous electrolyte secondary battery of each of the Examples and the Comparative Examples.

TABLE 1

| | | | | | Charge and discharge cycles | |
|---|---|---|---|---|---|---|
| | Positive electrode active material | | | Non-aqueous | (300 cycles) | |
| | | | Compressive | electrolyte | Capacity | Rate of |
| | | Aggregated/ | strength | FEC content | maintenance | increase in |
| | Active material | unaggregated | (MPa) | (% by mass) | rate (%) | resistance (%) |
| Example 1 | Active material A | Unaggregated | 570 | 10 | 89 | 117 |
| Example 2 | Active material A | Unaggregated | 570 | 2 | 83 | 120 |
| Comparative Example 1 | Active material A | Unaggregated | 570 | — | 53 | 122 |
| Comparative Example 2 | Active material C | Aggregated | 132 | 10 | 81 | 150 |
| Comparative Example 3 | Active material C | Aggregated | 132 | 5 | 71 | 146 |
| Comparative Example 4 | Active material C | Aggregated | 132 | — | 62 | 142 |
| Example 3 | Active material B | Unaggregated | 256 | 10 | 90 | 134 |
| Comparative Example 5 | Active material D | Aggregated | 88 | 10 | 83 | 145 |

Examples 1 to 2 using a positive electrode active material including complex oxide particles, including Ni, Co, Mn and Li, wherein the ratio of Ni to the total number of moles of the metallic elements except Li is 50 mol % or more and Comparative Examples 1 to 4 are compared. Among these, a decrease in the capacity maintenance rate and a resistance increase in charge and discharge cycles in Examples 1 and 2, wherein the complex oxide particles are unaggregated particles and have a compressive strength of 250 MPa or more, and the non-aqueous electrolyte includes a fluorine-containing cyclic carbonate were suppressed as compared with Comparative Example 1, wherein the complex oxide particles are unaggregated particles and have a compressive strength of 250 MPa or more, but the non-aqueous electrolyte does not include a fluorine-containing cyclic carbonate; Comparative Examples 2 and 3, wherein the non-aqueous electrolyte includes a fluorine-containing cyclic carbonate, but the complex oxide particles are aggregated particles and have a compressive strength of less than 250 MPa; and Comparative Example 4, wherein the complex oxide particles are aggregated particles and have a compressive strength of less than 250 MPa, and the non-aqueous electrolyte does not include a fluorine-containing cyclic carbonate.

Examples 3 using a positive electrode active material including complex oxide particles, including Ni, Co, Al and Li, wherein the ratio of Ni to the total number of moles of the metallic elements except Li is 50 mol % or more and Comparative Examples 5 are compared. Among these, a decrease in the capacity maintenance rate and a resistance increase in charge and discharge cycles in Examples 3, wherein the complex oxide particles are unaggregated particles and have a compressive strength of 250 MPa or more, and the non-aqueous electrolyte includes a fluorine-containing cyclic carbonate were suppressed as compared with Comparative Examples 5, wherein the non-aqueous electrolyte includes a fluorine-containing cyclic carbonate, but the complex oxide particles are aggregated particles and have a compressive strength of less than 250 MPa.

### REFERENCE SIGNS LIST

10 non-aqueous electrolyte secondary battery
11 positive electrode
12 negative electrode
13 separator
14 electrode assembly
15 case body
16 sealing assembly
17,18 insulating plates
19 positive electrode lead
20 negative electrode lead
21 projecting portion
22 filter
22a opening of filter
23 lower vent member
24 insulating member
25 upper vent member
26 cap
26a cap opening
27 gasket

1. A non-aqueous electrolyte secondary battery, comprising:
a positive electrode;
a negative electrode; and
a non-aqueous electrolyte, wherein
the non-aqueous electrolyte includes a non-aqueous solvent including a fluorine-containing cyclic carbonate,
the positive electrode includes a positive electrode active material including complex oxide particles, including Ni, Co and Li and including at least either of Mn and Al, wherein a ratio of Ni to a total number of moles of metallic elements except Li is 50 mol % or more, and
the complex oxide particles are unaggregated particles and have a compressive strength of 250 MPa or more.

2. The non-aqueous electrolyte secondary battery according to claim 1, wherein
a content of the fluorine-containing cyclic carbonate in the non-aqueous solvent is 10% by volume or more based on a total volume of the non-aqueous solvent.

3. The non-aqueous electrolyte secondary battery according to claim 1, wherein
the ratio of Ni to the total number of moles of the metallic elements except Li is 80 mol % or more and 95 mol % or less in the complex oxide particles.
